(19) United States
(12) Patent Application Publication
(10) Pub. No.: US 2009/0144051 A1
(43) Pub. Date: Jun. 4, 2009

(54) METHOD OF PROVIDING PERSONAL DICTIONARY

(75) Inventors: Tae Hoon Lee, Seongnam-Di (KR); Jae Young Lee, Seoul (KR); Chiyung Ahn, Seoul (KR); Sung Won Choi, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, SEONGNAM-SI (KR)

(21) Appl. No.: 12/211,614

(22) Filed: Sep. 16, 2008

(30) Foreign Application Priority Data
Dec. 4, 2007 (KR) 10-2007-0125168

(51) Int. Cl. G06F 17/21

(52) U.S. Cl. 704/10

(57) ABSTRACT

Disclosed is a method of using a computerized dictionary for building an electronic word list. The method can include accessing a computerized dictionary, opening an entry of the dictionary for a word, the entry comprising a listing of a plurality of descriptions of the word, selecting a first one of the plurality of descriptions, and causing to store the first description or a portion thereof in an electronic word list of a user.

### CROSS-REFERENCE TO RELATED APPLICATION

This application claims priority to and the benefit of Korean Patent Application No. 10-2007-0125168, filed Dec. 4, 2007, the disclosure of which is incorporated herein by reference in its entirety.

### BACKGROUND

1. Field

The present disclosure relates to a dictionary service, and more particularly, to a method of constructing a user's word list in a computer.

2. Discussion of the Related Technology

Recently, a variety of portals provide an Internet dictionary service. According to the dictionary service, if a user inputs a keyword to search for a word, the service retrieves the word which meets the keyword from a variety of dictionaries and collects it to provide to the user. Moreover, the dictionary service provides a personal dictionary or user word list in which a user can store his or her searched words at the option.

The foregoing discussion is to provide general background information, and does not constitute an admission of the prior art.

### SUMMARY

One aspect of the invention provides a method of using a computerized dictionary for building an electronic word list. The method comprises: accessing a computerized dictionary; opening an entry of the dictionary for a word, the entry comprising a listing of a plurality of descriptions of the word; selecting a first one of the plurality of descriptions; and causing to store the first description or a portion thereof in an electronic word list of a user.

In the foregoing method, the plurality of descriptions of the word may comprise distinct items describing the word that are listed in the entry. The plurality of description may comprise a first description and a second description, wherein the first description may represent a first meaning of the word different from a second meaning of the word that the second description represents. The computerized dictionary may be a foreign language dictionary, in which the word may be in a first language and the plurality of descriptions may be in a second language other than the first language. Selecting may comprise clicking on an area of a screen which displays the first description.

Still in the foregoing method, the first description or the portion thereof may be stored as an entry of the electronic word list. The method may further comprise adding text to the entry of the electronic word list along with the first description or the portion thereof. The method may further comprise editing the first description or the portion thereof in the entry of the electronic word list. The dictionary may be an online dictionary and accessible via the Internet. Causing to store may comprise sending a request to store the first description or the portion thereof to a server associated with the online dictionary. Causing to store may comprise initiating to storing the first description or the portion thereof in a local device selected from the group consisting of a stand alone computer, a desktop computer, a notebook computer, a handheld computer, a mobile phone, a mobile communication device, a handheld electronic dictionary device, and a personal digital assistant (PDA).

Yet in the foregoing method, the dictionary may be stored in a local device selected from the group consisting of a stand alone computer, a desktop computer, a notebook computer, a handheld computer, a mobile phone, a mobile communication device, a handheld electronic dictionary device, and a personal digital assistant (PDA). Causing to store may comprise initiating to storing the first description or the portion thereof in the local device.

Another aspect of the invention provides electronic word list software for use with an on-line dictionary. The software comprises: a selection enabling module configured to enable a user to select a portion of a dictionary entry comprising a plurality of descriptions when the user opens the dictionary entry of a word; a storing module configured to store a selected portion in a local computer as an entry of an electronic word list when receiving a user's command to store; and a retrieving module configured to retrieve a stored entry of the electronic word list when receiving a user's command to retrieve the stored entry. The foregoing software may further comprise an editing module configured to permit the user to edit the selected portion after selection and prior to storing.

Still another aspect of the invention provides a method of providing an online dictionary service. The method comprises: receiving, from a user, a request to open a dictionary entry of a word, the entry comprising a listing of a plurality of descriptions of the word; receiving, from the user, a selection of a first one of the plurality of descriptions or a portion of the first description; and upon receipt of the selection, causing to store the first description or the portion thereof in an electronic word list for later look-up.

In the foregoing method, the plurality of description may comprise a first description and a second description, wherein the first description represents a first meaning of the word different from a second meaning of the word that the second description represents. The computerized dictionary may be a foreign language dictionary, in which the word is in a first language and the plurality of descriptions are in a second language other than the first language. The foregoing method may further comprise: receiving, from the user, text to store along with the first description or the portion thereof in the electronic word list; and storing the text along with the first description or the portion thereof in the electronic word list. Causing to store may comprise storing the first description or the portion thereof in a server associated with the online dictionary service or in a local device that accesses the on-line dictionary service.

It is, therefore, an aspect of the present invention to provide a personal dictionary service enabling a user to edit words, retrieved by using search term(s), by referring to a plurality of meanings included in each of the words when recording them in the user's personal dictionary.

Furthermore, it is another aspect of the present invention to provide a personal dictionary service with a test function for the language learning by using the information recorded in a personal dictionary database and with a output function for the language learning by putting out vocabulary information in a form of playable digital files such as MP3 file or Excel, Word, text files etc.

In accordance with an aspect of the present invention, there is provided a method for providing a personal dictionary which is editable by using at least one of dictionary database containing commonly used dictionary data and personal dictionary database created by selecting at least a specific dictionary data among the dictionary data included in the dictionary database, wherein each of the dictionary data included in the dictionary database and the personal dictionary database includes one or more words, each of the words including at least a meaning thereof, including the steps of: (a) receiving a search term inputted by a user; (b) retrieving information on a specific vocabulary meeting the search term from the dictionary data stored in at least one of the dictionary database and the personal dictionary database, and then displaying the retrieved information; (c) receiving selection information from the user, the selection information representing information on at least part of the meanings selected among the meanings included in the specific vocabulary; and (d) recording dictionary data corresponding to the selection information in a personal dictionary database belonging to the user among the personal dictionary database.

In accordance with another aspect of the present invention, there is provided a system for providing a personal dictionary which is editable to a user including: a dictionary database for containing dictionary data commonly used, the dictionary data including at least one word and each word having at least one meaning; a personal dictionary database created by selecting by the user at least part of the information on the dictionary data included in the dictionary database; a result page creating part for providing the user with a result page including at least one vocabulary obtained from at least one of the dictionary database and the personal dictionary database and at least one meaning corresponding to the vocabulary by a retrieval through a search term received from the user; and a dictionary editing part for receiving selection information including information on at least part of the meanings selected among the result page, creating personal dictionary data on the basis of the received selection information, and recording the created personal dictionary data in the personal dictionary database.

### BRIEF DESCRIPTION OF THE DRAWINGS

The above and other aspects and features of the present invention will become apparent from the following description of embodiments given in conjunction with the accompanying drawings, in which:

FIG. 1 refers to a configuration of a personal dictionary system 100 for providing a freely editable personal dictionary by meanings of words in accordance with one embodiment of the present invention.

FIG. 2 shows a flowchart illustrating an order of a method for providing the freely editable personal dictionary by the meanings of the words in accordance with one embodiment of the present invention.

FIG. 3 represents a diagram showing a service screen provided by a dictionary editing part 120 for offering the freely editable personal dictionary by the meanings of the words in accordance with one embodiment of the present invention.

FIGS. 4A and 4B indicate diagrams illustrating the examples of the service screen provided by a vocabulary testing part 130 in accordance with one embodiment of the present invention.

FIG. 5 presents a diagram indicating a test result by each user.

FIGS. 6A through 6C offer diagrams illustrating examples of the service screen provided by an output part 140 in accordance with one embodiment of the present invention.

### DETAILED DESCRIPTION OF EMBODIMENTS

Various embodiments of the present invention will be described with reference to the attached drawings.

In the following detailed description, reference is made to the accompanying drawings that show, by way of illustration, specific embodiments. These embodiments are described in sufficient detail to enable those skilled in the art to practice the invention. It is to be understood that various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In a personal dictionary service, when a user intends to store the specific words in the personal dictionary, the specific words included in a dictionary database may be recorded in the personal dictionary as they are. For the reason, such Internet dictionary service may not be able to satisfy the user who intends to create a personal dictionary by focusing on specific meanings or particular parts of the specific words stored in the dictionary database.

By reference to the attached drawings, embodiments of the present invention are explained in detail as follows:

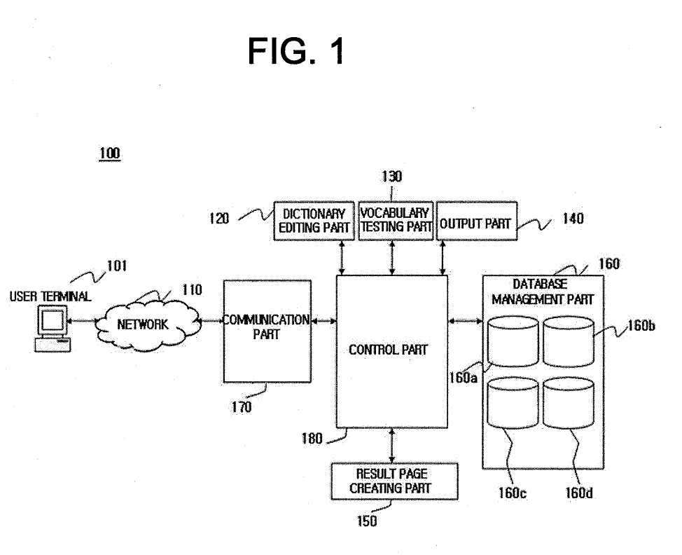

In accordance with one embodiment of the present invention, FIG. 1 shows a configuration of a personal dictionary system 100 for providing a freely editable personal dictionary. By reference to FIG. 1, the personal dictionary system 100 may include a dictionary editing part 120, a vocabulary testing part 130, an output part 140, a result page creating part 150, a database management part 160, a communication part 170, a control part 180 etc.

In accordance with one embodiment of the present invention, at least part of the dictionary editing part 120, the vocabulary testing part 130, the output part 140, the result page creating part 150, the database management part 160, the communication part 170, and the control part 180 may be included in the personal dictionary system 100 or may be program modules communicating with the personal dictionary system 100. However, FIG. 1 shows configuration of the personal dictionary system 100 including the dictionary editing part 120, the vocabulary testing part 130, the output part 140, the result page creating part 150, the database management part 160, the communication part 170, and the control part 180. The program modules may be included in a user terminal with a form of OS, application program module, or other types of program modules and recorded in a plurality of well-known memory units. Moreover, the program modules may be recorded in remote controllable memory units capable of communicating with the user terminal. The program modules may include routine, subroutine, program, object, component, data structure and the like capable of executing specific tasks which will be explained in this specification, but not confined thereto.

Herein, the division of the system 100 into the plurality of parts, i.e., the dictionary editing part 120, the vocabulary testing part 130, the output part 140, the result page creating part 150 and the like is determined for convenience's sake in order to carry out user friendly functions, which allow users to edit dictionary data and test their memory by using the edited dictionary data or output the edited dictionary data with a form of printout or MP3 file to memorize them easily and conveniently, but it is not limited thereto.

In accordance with one embodiment of the present invention, the result page creating part 150 retrieves vocabulary meeting a search term inputted by a user from the dictionary database 160b or already created user word list or personal dictionary database 160c to thereby provide information on the vocabulary to the user terminal. The user may be allowed to produce a personal dictionary or user word list by using a result page including the information on the vocabulary.

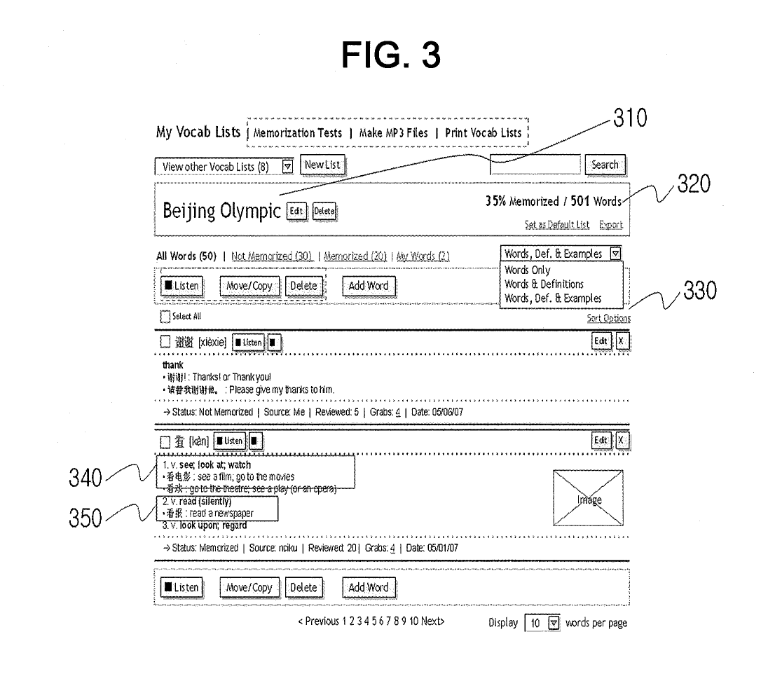

When the result page created by the result page creating part 150 is displayed through the screen of the user terminal, the dictionary editing part 120 provides the user friendly interface for enabling the user to relocate the items displayed on the result page for the user's preference or edit the dictionary data. The process executed by the dictionary editing part 120 will be described in more detail below by reference of FIG. 3.

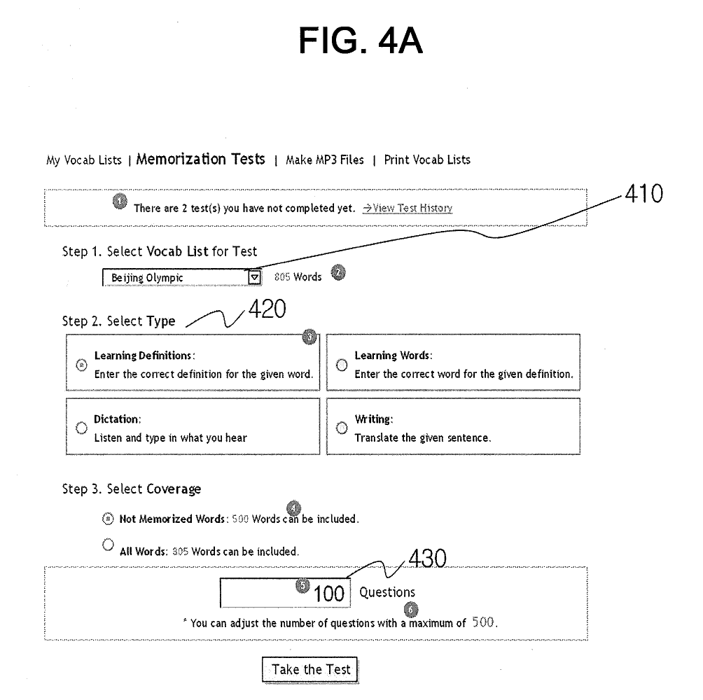

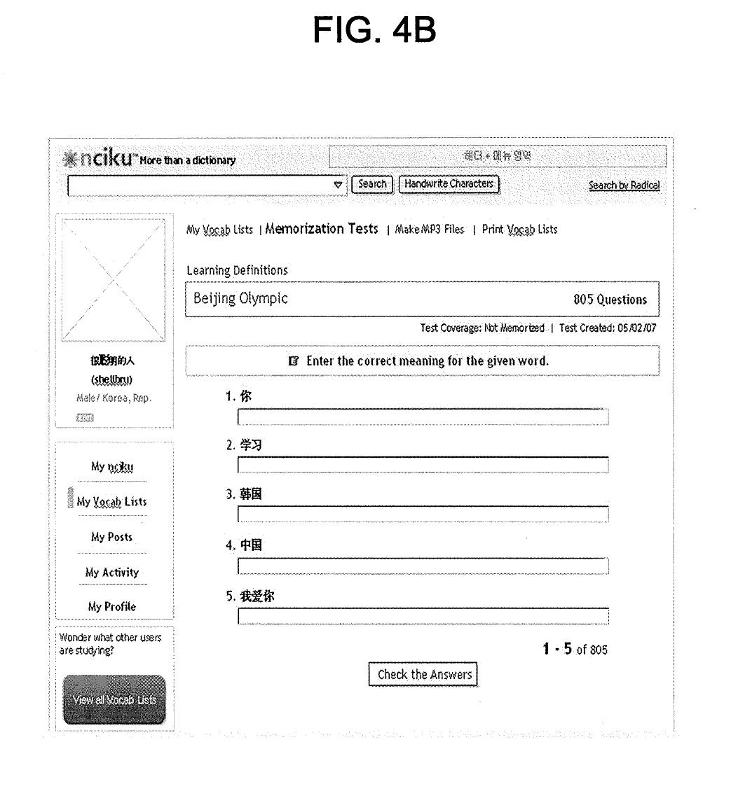

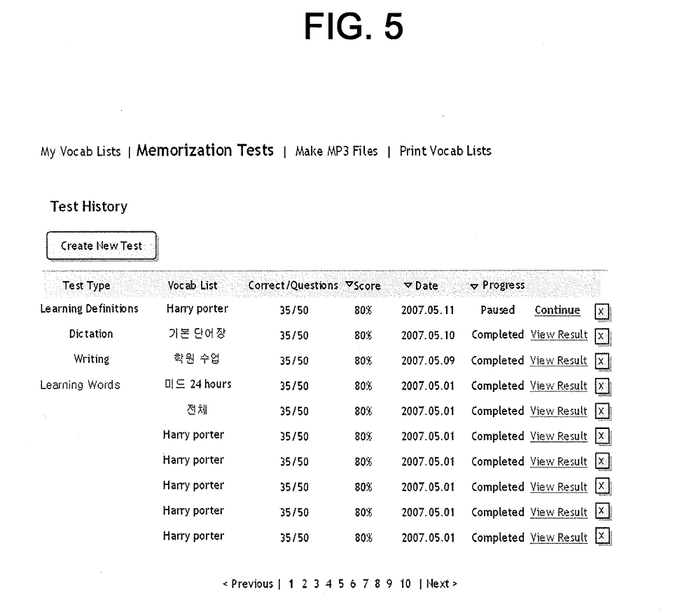

In accordance with one embodiment of the present invention, the vocabulary testing part 130, then, offers the user some items that can diagnose the learning state of the user based on the dictionary data and provides the function of evaluating the responses of the user. More specifically, the vocabulary testing part 130 can provide a method of suggesting vocabulary and receiving meanings, a method of suggesting meanings and receiving vocabulary, and a method of testing such as dictation and writing. In addition, the vocabulary testing part 130 may record the history of the test result in a history database 160d to thereby allow the user to refer to the vocabulary test result carried out by the user or to restart the once-suspended test. The process by the vocabulary testing part 130 will be described in more detail below by reference of FIGS. 4 and 5.

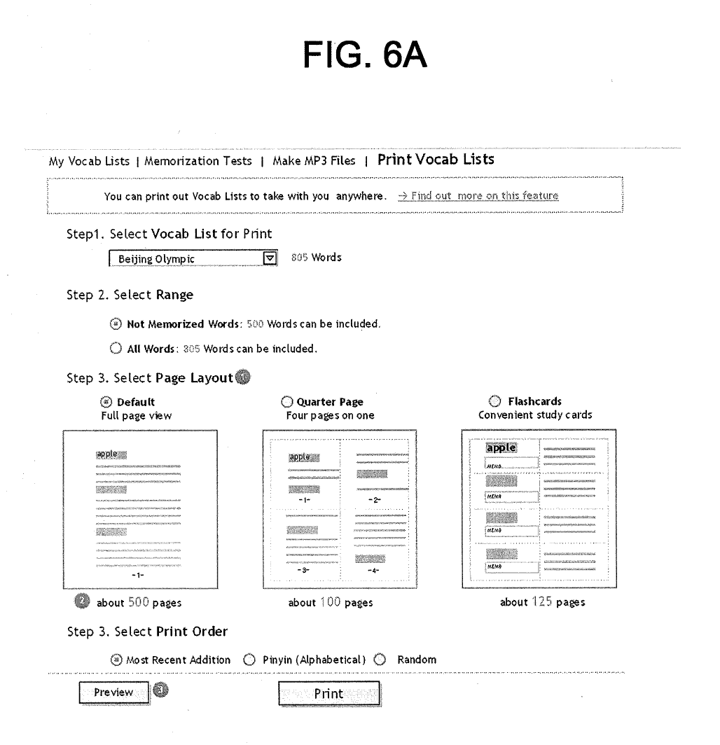

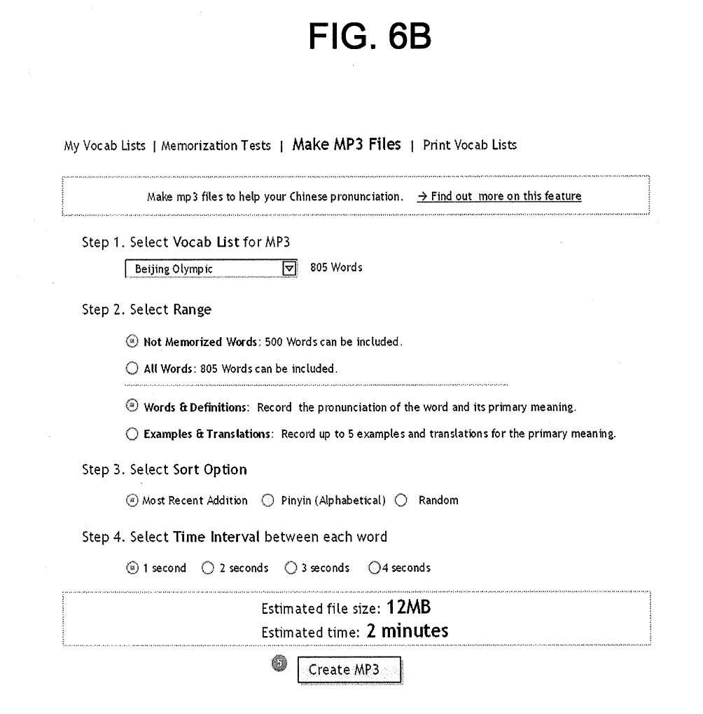

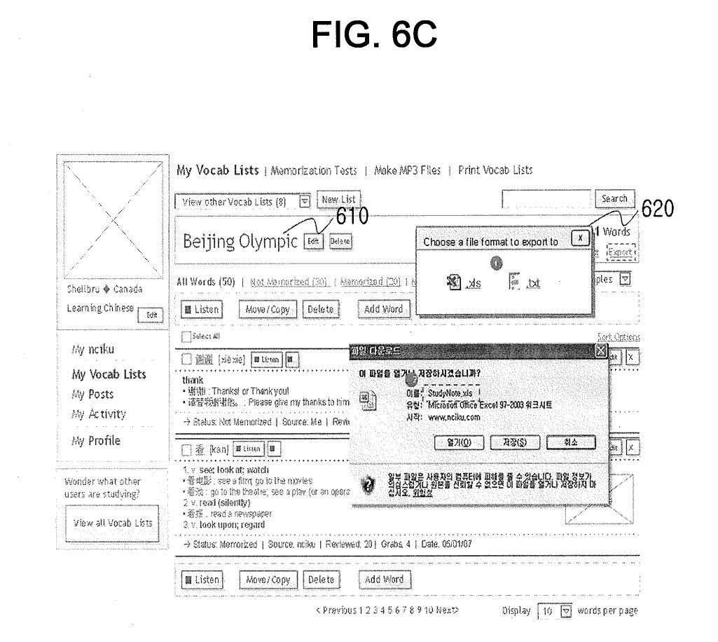

Furthermore, the output part 140 in accordance with one embodiment of the present invention performs the functions of printing out part or whole of the dictionary data to a paper, encoding the dictionary data into a format of a digital file playable such as mp3, or outputting the dictionary data as a format of Excel, Word or the like, thereby allowing the user to study vocabulary recorded in the personal dictionary offline. The process by the output part 140 will be described in more detail below by reference of FIG. 6.

In accordance with one embodiment of the present invention, the database management part 160 performs the functions of maintaining and managing a variety of databases. The database management part 160 may include user information database 160a, the dictionary database 160b, the personal dictionary database 160c and the history database 160d, which are classified for convenience's sake to provide the user with the dictionary service and register and maintain the dictionary data for the user, but the configuration of the database management part 160 is not limited thereto. The databases included in the database management part 160 may be integrated or divided for the effectiveness and convenience of the system management.

The user information database 160a may be used to store the information on the user and it may include the user name, ID, password, address, contact number, email address, points and the like. The dictionary database 160b may include various dictionary data existing on the network. If a user inputs a search term to retrieve the dictionary data for the personal dictionary, the vocabulary meeting the search term may be acquired from the dictionary database 160b. The personal dictionary database 160c may be created by each user with the use of the dictionary database 160b or may be recorded by editing the dictionary data contained in the dictionary database 160b.

The history database 160d may include the information on the state and/or the results of the learning test carried out by the vocabulary testing part 130. A variety of databases mentioned in embodiments of the present invention, including the user information database 160a, the dictionary database 160b, the personal dictionary database 160c, and the history database 160d, may include database(s) in a narrow sense as well as database(s) in a broad sense including data record based on a file system. Moreover, each of the databases may be included in the personal dictionary system 100, but may exist in a remote memory device telecommunicable with the personal dictionary system 100.

Further, the communication part 170 may play a role in transmitting/receiving data to/from a remote computer or other devices connected with the personal dictionary system 100 through the network. For example, the communication part 170 may consist of a physical connector etc. for the communication with a remote computer such as a user terminal 101 and perform data communication through a certain communication protocol.

Lastly, the control part 180 may perform the function of controlling the data flow among the dictionary editing part 120, the vocabulary testing part 130, the output part 140, the result page creating part 150, the database management part 160, and the communication part 170. In other words, the control part 180 may let the dictionary editing part 120, the vocabulary testing part 130, the output part 140, the result page creating part 150, the database management part 160, and the communication part 170 carry out their unique functions by controlling the signal transmitted and received among the above-mentioned modules.

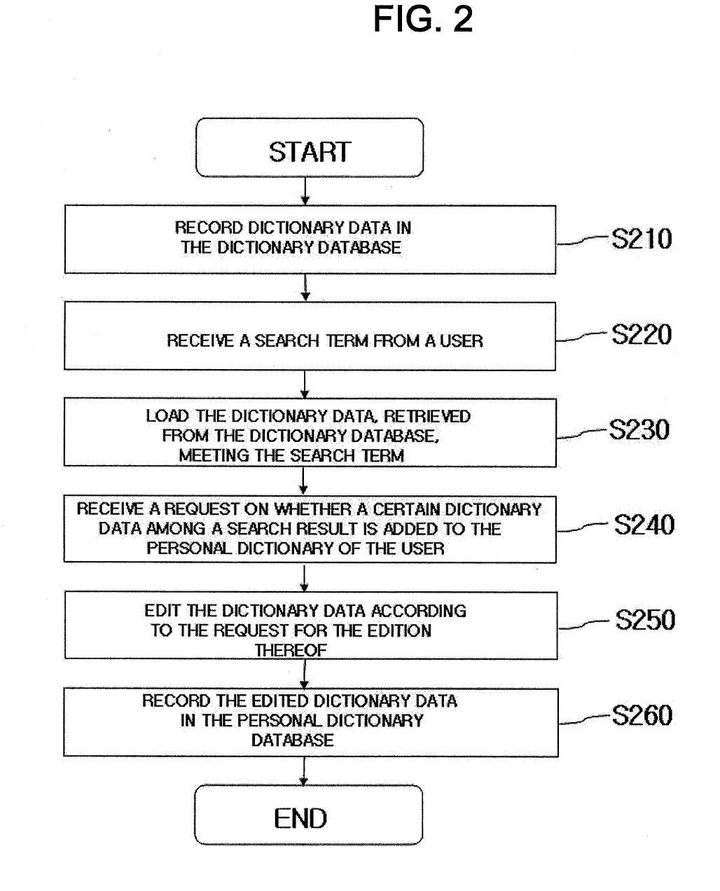

In accordance with one embodiment of the present invention, FIG. 2 shows a flowchart of a method for providing a freely editable personal dictionary by the meaning of vocabulary. By reference of FIG. 2, procedures for collecting the dictionary data which exist in the network and recording the collected dictionary data in the dictionary database 160b are preceded (step S210). Thereafter, the result page creating part 150 may receive a particular word as a search term from a user (step S220), retrieve the dictionary data meeting the search term from the dictionary database 160b or the personal dictionary database 160c and load the retrieved dictionary data on the user terminal as a search result (step S230). Herein, the search result provided to the user terminal may include various words acquired from the dictionary database 160b, the personal dictionary database 160c or the like. For instance, if a user enters “morning” as the search term, [symbol] (which is a Korean word that means “morning”), “Morgen,” [symbol] (which is a Japanese word that means “morning”) etc. may be provided to the user terminal at the same time.

The dictionary editing part 120 may receive a request on whether a certain dictionary data among the search result is added to the personal dictionary of the user (step S240). At the time, if the search result includes a word containing a plurality of meanings, the dictionary editing part 120 would receive the request on whether a specific meaning of the word is added to the personal dictionary or not.

The request mentioned in the step S240 may be clearly specified, but not always clearly specified. That is, it is possible that the certain dictionary data may be automatically added. For example of a non-specified request, if a user does not go through the log-in process, the personal dictionary system 100 may record the search result acquired at the step S230 in a temporary storage and then automatically put the information on the temporarily recorded words to the personal dictionary at the time when the user performs the log-in process later.

If the request of the user is specified, the user can designate or edit the parts to be added to the personal dictionary among the provided dictionary data (step S250). This may be performed under any one of the various methods as follows:

In accordance with one embodiment of the present invention, the dictionary editing part 120 may display the editing screen on which the user can edit at least part of the dictionary data provided to the user terminal at the step S230 and it may record the data edited by the user in the personal dictionary database 160c, on the request for the addition of the words.

In accordance with another embodiment of the present invention, if at least part of the dictionary data provided at the step S230 is specified by using an input device such as a mouse by the user, the dictionary editing part 120 may record the specified dictionary data in the personal dictionary database 160c automatically or on the request.

In accordance with still another embodiment of the present invention, the dictionary editing part 120 may provide a button or a checkbox for adding each of the meanings of the words to the personal dictionary database 160c.

To record the selected part of the dictionary data in the personal dictionary database 160c, the personal dictionary system 100 may classify the dictionary data stored in the dictionary database 160b on the basis of each meaning of the words before the user creates the personal dictionary, or the personal dictionary system 100 may extract a specific meaning from the dictionary data after the specific meaning is selected among the provided dictionary data. In particular, in case of the latter, if a button is activated or a text included in a location of a mouse is extracted by perceiving the location thereof, it may be implemented by providing the dictionary data with script codes for extracting the text.

If the editing procedure is completed for the dictionary data included in the personal dictionary, the dictionary editing part 120 may record the edited dictionary data in the personal dictionary database (step S260).

Herein, if the user requests an additional editing procedure for the dictionary data recorded in the personal dictionary database 160c later, the dictionary editing part 120 may revise the data recorded in the personal dictionary database 160c. For example, the opinion of the user or example sentences may be added to the dictionary data included in the personal dictionary or a part or the whole of such dictionary data may be edited, e.g., added, revised, deleted.

In accordance with another embodiment of the present invention, after recording the dictionary data selected by the user in the personal dictionary database 160c (step S260), the function of allowing a user to edit the recorded dictionary data may be provided (step S250).

As described above, the dictionary data recorded in the personal dictionary database 160c by a certain user may be exposed as a search result to other users, who may newly edit the search result, i.e., the dictionary data retrieved from the personal dictionary database 160c created by the certain user, for their requirements through the processes illustrated in FIG. 2.

In accordance with one embodiment of the present invention, FIG. 3 is a diagram illustrating a service screen provided by the dictionary editing part 120 for providing the freely editable personal dictionary service by the meaning of each word.

Each user may hold more than one personal dictionary in which the dictionary data are respectively recorded. If a user does not specify his or her personal dictionary, a certain personal dictionary, registered as a default one, may be loaded.

By reference of FIG. 3, a part 310 of “Beijing Olympic” shows a name of the currently activated personal dictionary among at least one personal dictionary belonging to a user. In addition, a word test result executed by the vocabulary testing part 130 may be summarized at every personal dictionary and the summarized test result may be displayed at every personal dictionary. Further, a part 320 of “35% memorized/501 word” is an example showing the total number of words stored in the activated personal dictionary and the present state of memorization of the user. That is, the personal dictionary titled “Beijing Olympic” 310 contains 501 words therein and the user hits the memorization rate of 35% as the test result.

Furthermore, the user may revise the name of the personal dictionary or words recorded in the personal dictionary. It may be possible to edit the dictionary data after opening an editing screen by pressing the “revise” button, but in accordance with one embodiment of the present invention, if a user selects a location where the user wants to edit with a mouse etc., an input box in which a text can be immediately inputted for the selected location is displayed, thus, the user can edit his or her personal dictionary more easily.

In addition, the user may use the order selection 330 to change the indication state in the order of, e.g., priorities of dictionaries, the importance for a TOEIC test, a difficulty, and add new words at a location where the user wants to place them. Furthermore, the user may not only change the order of words but also the order of multiple meanings of such words randomly by using the drag & drop. For instance, a region 340 shows the first meaning of the Chinese letter pronounced as ‘kan’ and a region 350 illustrates the second meaning thereof. It is possible to drag the region 350 and drop it on the top of the region 340. This would be implemented by using the programming schemes such as AJAX (Asynchronous Javascript and XML), Javascript, and Flash.

FIGS. 4a and 4b are diagrams illustrating the screen, provided by the vocabulary testing part 130, for diagnosing the learning state of the user in accordance with one embodiment of the present invention. Referring to FIG. 4A, a user can take a test with at least one personal dictionary and “Beijing Olympic” 410 represents the name of the personal dictionary selected by the user.

By reference to a region 420, it is found out that a user can select which test the user will take. For instance, the user can select at least one of all the test types, e.g., finding the correct meaning of a word, finding the correct word with a suggested meaning, dictation or composition.

In addition, by reference to the field 430, it is found that a user can perform a test with all words included in the personal dictionary 410 or with a part of the words by determining the number of the words to take a test.

FIG. 4B illustrates a test which gives a word and makes a user answer the meaning thereof. When the user inputs the answer to each question in the text box, the vocabulary testing part 130 may check whether the answer is correct or not by referring to the dictionary database 160b or the personal dictionary database 160c. In the latter case, if the user has selectively recorded only the meaning of [symbol] (which are Korean words that mean “nice weather”) for a word “good” in the personal dictionary database 160c, and the user inputs the answer [symbol] (which is Korean word that means “good”) for the given word “good”, the answer would be treated as incorrect. This would result from the intention of the user who optionally stores the particular meaning for such a word.

FIG. 5 shows statistic data provided for the test result. Such a result screen may be provided to the user at the time of ending the test, and stored in the history database 160d to help the user to systematically manage the improvement of the capability.

FIG. 6A through FIG. 6C are the diagrams illustrating a service screen provided by the output part 140 in accordance with one embodiment of the present invention.

FIG. 6A shows the service screen for printing the vocabulary stored in the personal dictionary database 160c on a paper. In the case, the user can designate items to be printed by selecting them among the dictionary data including vocabulary, learning information, meaning, and example sentence stored in the personal dictionary. By reference to FIG. 6A, it is found that the system allows a user to select a variety of layouts for vocabulary etc. to be printed.

FIG. 6B illustrates a service for converting the vocabulary stored in the personal dictionary database 160c into digital data which can be playable in a form of audio signals such as MP3 file.

The user may select at least one of vocabulary, meanings, example sentences, and translated sentences stored in the personal dictionary and convert it into digital data, and the output part 140 may provide the user with information, e.g., an expected MP3 file size and an expected time for the conversion. During the conversion process, it may offer the information on a progression rate and an expected completion time as well.

FIG. 6C shows a service for converting the dictionary data stored in the personal dictionary database 160c into digital data files such as a text file, an MS Excel file, and an MS Word file.

When a user selects a name of the personal dictionary 610 and clicks the “Export” button 620, the output part 140 may provide the interface with which the user selects a file format to be exported, and when the user selects a particular file format, the conversion will be proceeded according to the particular file format.

In accordance with embodiments of the present invention, when a user intends to store vocabulary information in a personal dictionary, the system enables the user to edit such words by the meanings of the words to thereby create the optimal personal dictionary excluding the meaning that the user does not want to memorize.

In accordance with embodiments of the present invention, it can provide the user with a variety of user friendly edit interface to effectively create the personal dictionary.

Furthermore, in accordance with embodiments of the present invention, the system can output a personal dictionary and provide a test function to a user in order for the user to effectively memorize the vocabulary contained in the personal dictionary.

Embodiments of the present invention can be implemented in a form of executable program command through a variety of computer means recordable to computer readable media. The computer readable media may include solely or in combination, program commands, data files and data structures. The program commands recorded to the media may be components specially designed for embodiments of the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of embodiments of the present invention and they can do the same in the opposite case.

Embodiments of the invention has been shown and described, but the invention is not limited thereto. It will be understood by those skilled in the art that various changes and modification may be made without departing from the spirit and scope of the invention as defined in the following claims.

What is claimed is:

1. A method of using a computerized dictionary for building an electronic word list, the method comprising:
accessing a computerized dictionary;
opening an entry of the dictionary for a word, the entry comprising a listing of a plurality of descriptions of the word;
selecting a first one of the plurality of descriptions; and
causing to store the first description or a portion thereof in an electronic word list of a user.

2. The method of claim 1, wherein the plurality of descriptions of the word comprises distinct items describing the word that are listed in the entry.

3. The method of claim 1, wherein the plurality of description comprises a first description and a second description, wherein the first description represents a first meaning of the word different from a second meaning of the word that the second description represents.

4. The method of claim 1, wherein the computerized dictionary is a foreign language dictionary, in which the word is in a first language and the plurality of descriptions are in a second language other than the first language.

5. The method of claim 1, wherein selecting comprises clicking on an area of a screen which displays the first description.

6. The method of claim 1, wherein the first description or the portion thereof is stored as an entry of the electronic word list.

7. The method of claim 6, further comprising adding text to the entry of the electronic word list along with the first description or the portion thereof.

8. The method of claim 6, further comprising editing the first description or the portion thereof in the entry of the electronic word list.

9. The method of claim 1, wherein the dictionary is an online dictionary and accessible via the Internet.

10. The method of claim 9, wherein causing to store comprises sending a request to store the first description or the portion thereof to a server associated with the online dictionary.

11. The method of claim 9, wherein causing to store comprises initiating to storing the first description or the portion thereof in a local device selected from the group consisting of a stand alone computer, a desktop computer, a notebook computer, a handheld computer, a mobile phone, a mobile communication device, a handheld electronic dictionary device, and a personal digital assistant (PDA).

12. Electronic word list software for use with an on-line dictionary, the software comprising:
a selection enabling module configured to enable a user to select a portion of a dictionary entry comprising a plurality of descriptions when the user opens the dictionary entry of a word;
a storing module configured to store a selected portion in a local computer as an entry of an electronic word list when receiving a user's command to store; and
a retrieving module configured to retrieve a stored entry of the electronic word list when receiving a user's command to retrieve the stored entry.

13. A method of providing an online dictionary service, the method comprising:
receiving, from a user, a request to open a dictionary entry of a word, the entry comprising a listing of a plurality of descriptions of the word;
receiving, from the user, a selection of a first one of the plurality of descriptions or a portion of the first description; and
upon receipt of the selection, causing to store the first description or the portion thereof in an electronic word list for later look-up.

14. The method of claim 13, wherein the plurality of description comprises a first description and a second description, wherein the first description represents a first meaning of the word different from a second meaning of the word that the second description represents.

15. The method of claim 13, wherein the computerized dictionary is a foreign language dictionary, in which the word is in a first language and the plurality of descriptions are in a second language other than the first language.

16. The method of claim 13, further comprising:
receiving, from the user, text to store along with the first description or the portion thereof in the electronic word list; and
storing the text along with the first description or the portion thereof in the electronic word list.

17. The method of claim 13, wherein causing to store comprises storing the first description or the portion thereof in a server associated with the online dictionary service or in a local device that accesses the on-line dictionary service.

18. The method of claim 13, further comprising the step of:
providing the user with a test on the basis of dictionary entries of words.

19. The method of claim 18, wherein the test offers questions by collecting only words that the user has failed to memorize.

20. The method of claim 13, wherein at least part of dictionary entries of words is converted into at least one of data files including an audio file or a file executable by a certain application program.
